(19) United States
(12) Patent Application Publication
(10) Pub. No.: US 2009/0319277 A1
(43) Pub. Date: Dec. 24, 2009

(54) Source Coding and/or Decoding

(75) Inventor: Alastair Black, London (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Expo (FI)

(21) Appl. No.: 11/887,318

(22) PCT Filed: Mar. 30, 2005
(86) PCT No.: PCT/IB2005/000847

§ 371 Date: Aug. 21, 2009

(51) Int. Cl. G10L 21/00

(52) U.S. Cl. 704/500; 704/E19.001

(57) ABSTRACT

A method of bandwidth expansion in which a low band signal is used to create an excitation signal for an LPC synthesis filter for producing a high band synthetic signal. An encoding process comprises: dividing a signal into a low band signal and a high band signal; coding the low band signal; analysing the high band audio signal to create filter coefficients; filtering the high band signal, using a filter configured by the created filter coefficients, to produce a residual signal; creating a measure of the residual signal; and outputting the coded low band signal, the created filter coefficients for the high band signal and the measure. A decoding process is similar to the reverse of the encoding process.

### CROSS REFERENCE TO RELATED APPLICATIONS

This application is the U.S. National Stage of International Application Number PCT/IB05/000847 filed on Mar. 30, 2005 which was published in English on Oct. 5, 2006 under International Publication Number WO 2006/103488.

### FIELD OF THE INVENTION

Embodiments of the invention related to source coding and/or decoding, in particular audio coding and/or decoding.

### BACKGROUND TO THE INVENTION

Audio source coding is used to compress audio data so that it can be stored or transmitted more effectively.

For example, a speech coder can encode speech very efficiently at low bit rates over a limited bandwidth. As most information contained in speech that is necessary for comprehension is carried by the lower frequency components, the speech coder typically encodes the speech over this low band. The higher frequency components that are not coded add character and timbre to the speech. As a consequence the coded speech when reproduced may sound slightly ‘thin’.

It would therefore be desirable to increase the bandwidth of the reproduced audio without significantly increasing the bit rate of the encoded audio. This would not only allow better speech reproduction but would enable the speech coder to more effectively encode music and other non-speech audio.

An improved coding technique could be used instead of increasing the bandwidth of reproduced audio without a significant increase in the bit rate of the encoded audio be used to maintain the bandwidth of the reproduced audio with a significant decrease in the bit rate of the encoded audio.

The mechanism by which the bandwidth may be increased is bandwidth expansion (BWE) technology. This is used to recreate the higher frequencies at audio reproduction.

A typical audio/speech coding system employing bandwidth expansion technology will split the signal to be encoded into high and low bands. The low band signal will then be encoded using standard coding technology such as Advanced Audio Coding (AAC), MPEG1 Layer III Coding (MP3) or Adaptive Multirate (AMR) etc, this is known as the “core codec”. The high band signal is then analysed. The parameters obtained from the high band analysis are then sent to the receiver as side information at a very low bit rate. At the receiver, the low band signal is decoded and synthesised first using the core decoder. This signal is then used in conjunction with the high band side information to recreate an approximation of the original high band signal. The synthesised low and high band signals are then combined to recreate the complete full band audio signal. The burden of encoding the high band frequencies is removed from the encoder, thereby allowing higher audio quality at a lower data rate.

WO98/57436 describes one form of BWE. The document describes source coding using spectral-band replication. High band spectral components are extrapolated or replicated from the low band spectral components using transposition while the spectral envelope of the replicated high band signal is constrained to resemble that of the originally encoded high band signal. The encoder sends the low band signal to the decoder and may additionally send side information describing the spectral envelope at high band of the encoded signal.

### BRIEF DESCRIPTION OF THE INVENTION

According to one embodiment of the invention there is provided a method of bandwidth expansion in which a low band signal is used to create an excitation signal for an LPC synthesis filter for producing a high band synthetic signal.

According to another embodiment of the invention there is provided an encoder comprising: a signal divider for dividing a signal into a low band signal and a high band signal; a coder for coding the low band signal; an analyser for analysing the high band audio signal to create filter coefficients; a filter configurable by the created filter coefficients for filtering the high band signal to produce a residual signal; circuitry for creating a measure of the residual signal; and circuitry for outputting the coded low band signal, the created filter coefficients for the high band signal and the measure.

According to another embodiment of the invention there is provided an encoding process comprising: dividing a signal into a low band signal and a high band signal; coding the low band signal; analysing the high band audio signal to create filter coefficients; filtering the high band signal, using a filter configured by the created filter coefficients, to produce a residual signal; creating a measure of the residual signal; and outputting the coded low band signal, the created filter coefficients for the high band signal and the measure.

According to a further embodiment of the invention there is provided a decoder comprising: an input for receiving a low band input signal, a high band input measure and high band filter coefficients; a decoder for decoding the input low band signal to create a synthetic low band signal; circuitry for producing a low band excitation signal; circuitry for creating a measure of the low band excitation signal; circuitry for adjusting the low band excitation signal using the created measure of the low band excitation signal and the input high band measure; a filter configurable by the input high band filter coefficients and excitable by the adjusted low band excitation signal to produce a synthetic high band signal; and a signal combiner for combining the synthetic low band signal and the synthetic high band signal to create an output signal.

According to another embodiment of the invention there is provided a filter for a decoder operable to produce a high band synthetic signal comprising: a first input for receiving filter coefficients derived from a high band signal at an encoder; a second input for receiving an excitation signal that is dependent upon a low band excitation signal; and an output for providing the high band synthetic signal.

According to another embodiment of the invention there is provided a decoder for producing an output signal comprising: an input for receiving an input signal, an input measure and input filter coefficients; a decoder for decoding the input signal to create a first synthetic signal; an analyser for analysing the first synthetic signal to create filter coefficients; a first filter configurable by the created filter coefficients for filtering the first synthetic signal to produce an excitation signal; circuitry for creating a measure of the excitation signal; circuitry for adjusting the excitation signal using the created measure of the excitation signal and the input measure; a second filter configurable by the input filter coefficients and excitable by the adjusted excitation signal to produce a second synthetic signal; and a signal combiner for combining the first synthetic signal and the second synthetic signal to create an output signal.

According to another embodiment of the invention there is provided a decoding process comprising: decoding a low band signal to create a synthetic low band signal; producing a low band excitation signal; creating a measure of the low band excitation signal; adjusting the low band excitation signal using the created measure of the low band excitation signal and a high band measure; exciting a filter configured by high band filter coefficients using the adjusted low band excitation signal to produce a synthetic high band signal; and combining the synthetic low band signal and the synthetic high band signal to create an output signal.

### BRIEF DESCRIPTION OF THE DRAWINGS

For a better understanding of the present invention reference will now be made by way of example only to the accompanying drawings in which:

FIG. 1 illustrates an audio encoder 10;

FIG. 2 illustrates an audio decoder 50;

FIG. 3 illustrates a mobile telephone comprising both the audio encoder and audio decoder; and

FIG. 4 illustrates an electronic device comprising both the audio encoder and audio decoder.

### DETAILED DESCRIPTION OF EMBODIMENTS OF THE INVENTION

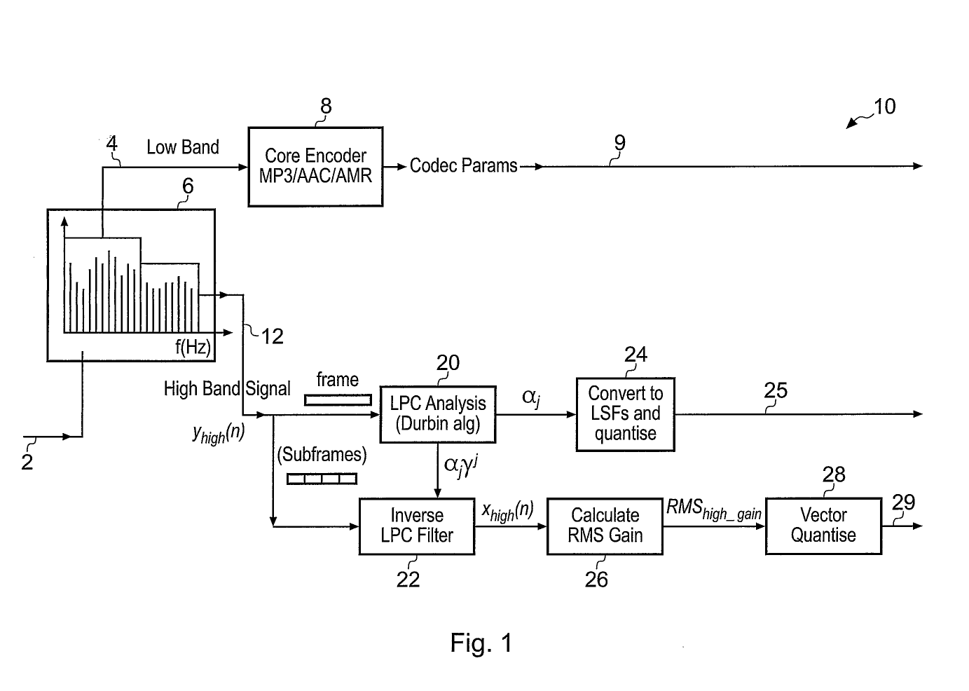

FIG. 1 illustrates a audio encoder 10. A digitized audio signal 2 is input to the audio encoder 10. The input signal 2 is divided into a high band signal 12 and a low band signal 4 by the signal divider 6. The signal divider 6 may, for example, be a symmetrical Quadrature Mirror Filter (QMF) synthesis filterbank or a Modified Discrete Cosine Transform (MDCT) filterbank. In this example, the digitized audio input signal is a 24 kHz signal, the low band signal is for frequencies between 0 Hz and 12 kHz and the high band signal is for frequencies between 12 kHz and 24 kHz. However, other frequency ranges may be used and the frequency ranges may partially overlap or may be distinct i.e. non-overlapping.

The low band signal is encoded with a core codec 8, in this case an Adaptive Multirate-Wideband (AMR-WB) speech codec to produce an encoded low band signal 9. This signal will typically be represented parametrically.

In other implementations other types of core codecs may be used such as, for example, Advanced Audio Coding (AAC), MPEG1 Layer III Coding (MP3) etc.

The high band signal 12 is then encoded. The coding frame rate is dependent on the expansion ratio. For a bandwidth expansion from 12 kHz to 24 kHz the algorithm utilises a frame length of 480 samples which is divided into 4 equal subframes of 120 samples.

First, at a Linear Predictive Coding (LPC) analyser 20, LPC analysis is performed over the high band signal 12 on a frame by frame basis. The LPC coefficients αⱼ produced are used to model the spectral envelope of the high band signal 12, in the form of the LPC synthesis filter given by:

$$H ( z ) = \frac{1}{1 - {\sum }_{j = 1}^{p} {α}_{j} {γ}^{j} {z}^{- j}} \qquad ( 1 )$$

where: αⱼ are the LPC coefficients, and p is the number of LPC coefficients. In order to ensure the stability of this filter the LPC coefficients are expanded by a factor γ. This has the effect of pulling the poles of the equation in towards the Z-domain unit circle resulting in “dampening” the filter. This ensures that no annoying artefacts are produced for resonant speech material, or highly harmonic audio material.

The LPC coefficients αⱼ, at quantizer 24, are then transformed to Line Spectral Frequencies (LSF) and quantised for transmission as quantised LSFs 25 to a receiver 50.

Simultaneously, at the LPC inverse filter 22, the expanded LPC coefficients are used to inverse filter the high band signal 12. For each sub-frame, the high band signal 12 is inverse LPC filtered, in order to obtain a residual signal:

$${x}_{high} ( n ) = {y}_{high} ( n ) - {\sum }_{j = 1}^{p} {α}_{j} {y}_{high} ( n - j ) for n = 0 … L - 1 \qquad ( 2 )$$

where: αⱼ are the expanded LPC coefficients, y(n) is the input vector, x(n) is the output vector from the filtering process (the residual vector) and L is the subframe length.

The residual signal x(n) from the LPC inverse filter 22 is provided to a gain calculator 26. At the gain calculator 26, the root mean square (RMS) energy of the residual signal x(n) is calculated. The RMS energy of the residual signal is in effect an excitation vector gain for the LPC analysis filter and may be referred to as a high band gain factor.

$$RM {S}_{gain \_ high} = \sqrt{\frac{1}{L} {\sum }_{0}^{L - 1} {x}_{high} ( n ) \cdot {x}_{high} ( n )} \qquad ( 3 )$$

The RMS energy values (high band gain factors) for all four sub-frames are collated together and vector quantised at quantizer 28 to enable efficient transmission to the decoder 50.

The encoder then sends the encoded low band signal 9, the quantised high band LSFs 25 and the quantised collated RMS energies 29 of the residual signals to the decoder 50 at the receiver for each frame.

Typically, the amount of side information used to transmit the quantised high band LSFs 25 and quantised RMS energies 29 is approximately 1.2 kbits/sec when the decoder expands from 12 kHz bandwidth to 24 kHz.

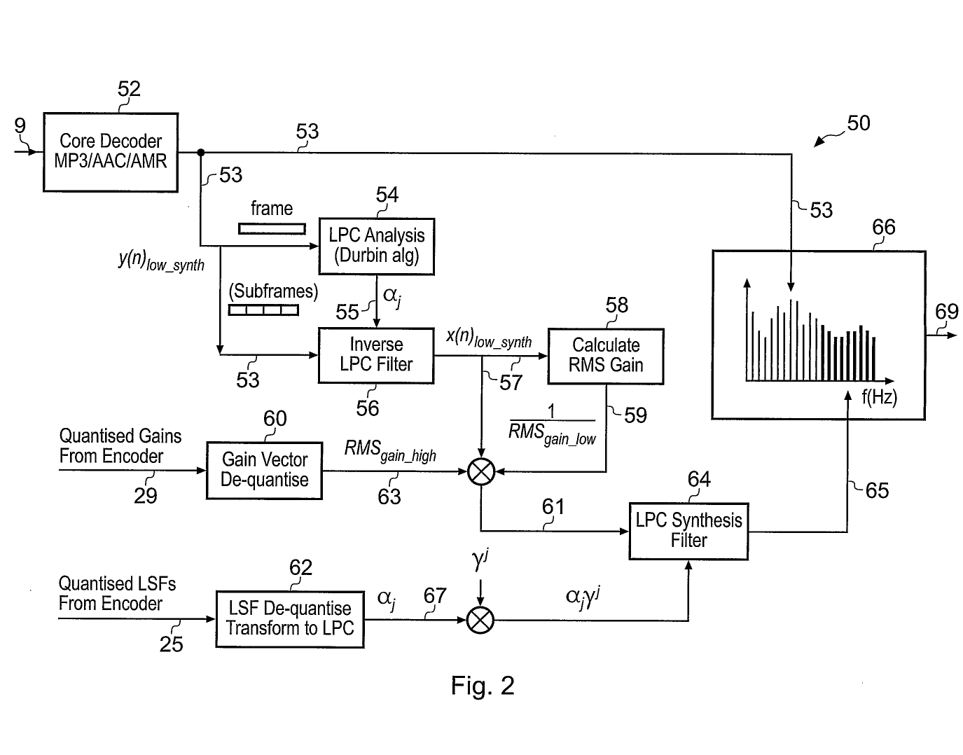

FIG. 2 illustrates an audio decoder 50. At the decoder 50, the received encoded low band signal 9 is decoded by a core codec 52, in this case an AMR-WB codec to produce a synthetic low band signal 53.

The received high band LSFs 25 are dequantized and transformed in dequantizer 62 to give the LPC filter coefficients 67 (αⱼ) for the frame. In addition the received quantised collated RMS energies 29 of the residuals are de-quantised in dequantizer 60 and un-collated to recover the high band gain factor 63 for each of the four subframes.

The low band synthetic signal 53 is then used in the formation of a high band synthetic signal 65. First, at an LPC analyser 54, LPC analysis is performed over the synthetic low band signal frame. The LPC coefficients 55 are used to model the spectral envelope of the synthetic low band signal 53.

At the LPC inverse filter 56, the LPC coefficients 55 are used to inverse filter the synthetic low band signal 53 in order to obtain a low band synthetic residual signal 57. This signal, as it is eventually used to excite the LPC synthesis filter 64 may also be called an excitation vector signal 57 (x_{low}_{_{—}}_{synth}(n).

$${x}_{low \_ synth} ( n ) = {y}_{low \_ synth} ( n ) - {\sum }_{j = 1}^{p} {α}_{j} {y}_{low \_ synth} ( n - j ) for n = 0 … L - 1 \qquad ( 4 )$$

This low band excitation vector 57 is then divided into subframe lengths, and for each subframe the RMS energy (low band gain factor) 59 is calculated at gain calculator 58 using:

$$RM {S}_{gain \_ low} = \sqrt{\frac{1}{L} {\sum }_{0}^{L - 1} {x}_{low \_ synth} ( n ) \cdot {x}_{low \_ synth} ( n )} \qquad ( 5 )$$

The low band gain factor 59 is then used to normalise the low band excitation vector 57, such that the vector has unit energy. The low band excitation vector 57 is additionally rescaled using the decoded high band gain 63 to create the rescaled excitation vector 61.

$${x}_{high \_ synth} ( n ) = \frac{RM {S}_{gain \_ high}}{RM {S}_{gain \_ low}} \times {x}_{low \_ synth} ( n ) for n = 0 , 1 … L - 1 \qquad ( 6 )$$

The rescaled low band excitation vector 61 is then used as the excitation input to a high band LPC synthesis filter 64 (the coefficients 67 for this filter were transmitted from the encoder 10). The output resulting from the filter 64 is the synthetic high band signal 65.

The process used to generate the rescaled low band excitation vector 61, as described above, is performed on a subframe basis. Consequently, the synthetic high band signal 65 is produced on a subframe basis. Once a frame of the high band synthetic signal 65 has been formed, it is then combined in combiner 66 with the corresponding synthetic low band signal 53 to form the full band signal 69. The combiner may be a symmetrical QMF synthesis filterbank or an MDCT filterbank.

In LPC analysis the short term correlations between samples are removed by a short order filter. It is sometimes called short term prediction (STP). This filtering removes the input signal's slowly varying spectral envelope.

In the above described example, a core codec is used to create the low band synthetic signal 53. The production of the synthetic high band signal uses the standard output of the core codec, its synthetic signal, as one input. Consequently prior art core codecs may be used as the core codec 52 without modification. The output of the core codec 52 is analysed and inverse filtered to create the low band excitation signal 57. In other implementations, a signal produced in the core codec 52 may be taken directly as the low band excitation signal 57. This signal may, for example, be the excitation vector that is used to excite an LPC synthesis filter within the core codec during production of the synthetic low band signal 53.

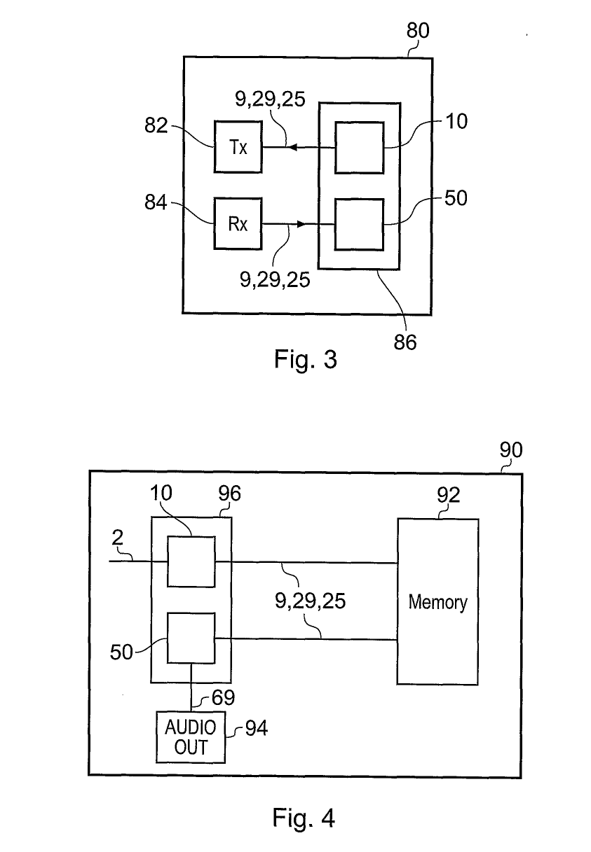

Although in this description, references is made to encoding at a transmitter and decoding at a receiver other arrangements are possible. For example a single device may at different times operate as a transmitter 82 and as a receiver 84. The mobile telephone 80, schematically illustrated in FIG. 3, has an audio encoder 10 for providing data to the transmitter 82 and an audio decoder 50 for receiving data from the receiver 84. The encoder 10 and decoder 50 may be provided on a chip-set 86.

An electronic device 90, as illustrated in FIG. 4, may have both an audio encoder 10 and an audio decoder 50. It may encode an audio signal 2 for efficient storage in a memory 92 and subsequently decode the stored signal 9, 29, 25 to produce an output audio signal 69 that is provided to an audio output device 94. The encoder 10 and decoder 50 may be provided on a chip-set 96.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A decoder comprising:
an input for receiving a low band input signal, a high band input measure and high band filter coefficients;
a decoder for decoding the low band input signal to create a synthetic low band signal;
circuitry for producing a low band excitation signal, for creating a measure of the low band excitation signal, and for adjusting the low band excitation signal using the created measure of the low band excitation signal and the input high band measure;
a filter configurable by the input high band filter coefficients and excitable by the adjusted low band excitation signal to produce a synthetic high band signal; and
a signal combiner for combining the synthetic low band signal and the synthetic high band signal to create an output signal.

2. A decoder as claimed in claim 1, wherein the means for adjusting the low band excitation signal using the created measure of the low band excitation signal adjusts the gain of the low band excitation signal.

3. A decoder as claimed in claim 1, wherein the means for adjusting the low band excitation signal using the created measure divides the low band excitation signal by the created measure and multiplies it by the high band input measure.

4. A decoder as claimed in claim 1, wherein the created measure is a measure of the energy of the low band excitation signal.

5. A decoder as claimed in claim 1, wherein the created measure is the root mean square of the low band excitation signal.

6. A decoder as claimed in claim 1, wherein the high band input measure is a measure of gain for the current subframe of the low band excitation signal.

7. A decoder as claimed in claim 1, wherein the low band excitation signal is produced on a subframe by subframe basis.

8. A decoder as claimed in claim 1, wherein the input high band filter coefficients produce LPC filter coefficients and the filter is an LPC synthesis filter.

9. A decoder as claimed in claim 1, wherein the low band excitation signal is produced from the synthetic low band signal.

10. A decoder as claimed in claim 9, further comprising:
an analyser for analysing the synthetic low band signal to create filter coefficients; and
a further filter configurable by the created filter coefficients for filtering the synthetic low band signal to produce the low band excitation signal.

11. A decoder as claimed in claim 10, wherein the created filter coefficients are LPC filter coefficients and the further filter is an inverse LPC filter.

12. A decoder as claimed in claim 11, wherein the LPC filter coefficients are produced on a frame by frame basis.

13. A decoder as claimed in claim 1, wherein the low band excitation signal is produced during production of the synthetic low band signal

14. A filter for a decoder operable to produce a high band synthetic signal comprising:
a first input for receiving filter coefficients derived from a high band signal at an encoder;
a second input for receiving an excitation signal that is dependent upon a low band excitation signal; and
an output for providing the high band synthetic signal.

15. A method of bandwidth expansion in which a low band signal is used to create an excitation signal for an LPC synthesis filter for producing a high band synthetic signal.

16. A method as claimed in claim 15, wherein the low band synthetic signal is used to create a low band excitation signal which is adjusted for use as the excitation signal for the LPC synthesis filter.

17. A method as claimed in claim 15, wherein an excitation signal used in the creation of a low band synthetic signal is adjusted for use as the excitation signal for the LPC synthesis filter.

18. A method as claimed in claim 16 wherein adjustment adjusts the gain of the excitation signal.

19. A decoder for producing an output signal comprising:
an input for receiving an input signal, an input measure and input filter coefficients;
a decoder for decoding the input signal to create a first synthetic signal;
an analyser for analysing the first synthetic signal to create filter coefficients;
a first filter configurable by the created filter coefficients for filtering the first synthetic signal to produce an excitation signal;
circuitry for creating a measure of the excitation signal, and for adjusting the excitation signal using the created measure of the excitation signal and the input measure;
a second filter configurable by the input filter coefficients and excitable by the adjusted excitation signal to produce a second synthetic signal; and
a signal combiner for combining the first synthetic signal and the second synthetic signal to create an output signal.

20. A decoder as claimed in claim 19, wherein the created filter coefficients are LPC filter coefficients and the first filter is an inverse LPC filter

21. A decoder as claimed in claim 19, wherein the input filter coefficients are LPC filter coefficients and the second filter is an LPC synthesis filter.

22. An encoder comprising:
a signal divider for dividing a signal into a low band signal and a high band signal;
a coder for coding the low band signal;
an analyser for analysing the high band audio signal to create filter coefficients;
a filter configurable by the created filter coefficients for filtering the high band signal to produce a residual signal;
means for creating a measure of the residual signal;
output means for outputting the coded low band signal, the created filter coefficients for the high band signal and the measure.

23. An encoder as claimed in claim 22, wherein the filter coefficients are LPC filter coefficients and the filter is an inverse LPC filter.

24. An encoder as claimed in claim 23, wherein the LPC filter coefficients are produced on a frame by frame basis

25. An encoder as claimed in claim 22, wherein the residual signal is produced on a subframe by subframe basis.

26. An encoder as claimed in claim 22, wherein the measure is a measure of the energy of the residual signal.

27. An encoder as claimed in claim 22, wherein the measure is the root mean square of the residual signal.

28. An encoder as claimed in claim 22, wherein the measures for each subframe are collated to create a measure for the frame that is quantised before output.

29. An electronic device comprising an encoder as claimed in claim 22 and a decoder as claimed in claim 1.

30. A decoding process comprising:
decoding a low band signal to create a synthetic low band signal;
producing a low band excitation signal;
creating a measure of the low band excitation signal;
adjusting the low band excitation signal using the created measure of the low band excitation signal and a high band measure;
exciting a filter configured by high band filter coefficients using the adjusted low band excitation signal to produce a synthetic high band signal; and
combining the synthetic low band signal and the synthetic high band signal to create an output signal.

31. An encoding process comprising:
dividing a signal into a low band signal and a high band signal;
coding the low band signal;
analysing the high band audio signal to create filter coefficients;
filtering the high band signal, using a filter configured by the created filter coefficients, to produce a residual signal;
creating a measure of the residual signal; and
outputting the coded low band signal, the created filter coefficients for the high band signal and the measure.

32. A decoder comprising:
means for receiving a low band input signal, a high band input measure and high band filter coefficients;
means for decoding the input low band signal to create a synthetic low band signal;
means for producing a low band excitation signal
means for creating a measure of the low band excitation signal;
means for adjusting the low band excitation signal using the created measure of the low band excitation signal and the input high band measure;
means configurable by the high band filter coefficients and excitable by the adjusted low band excitation signal for producing a synthetic high band signal; and
a signal combiner means for combining the synthetic low band signal and the synthetic high band signal to create an output signal.

33. A decoder for producing an output signal comprising:
an input for receiving an input signal, an input measure and input filter coefficients;
a decoder for decoding the input signal to create a first synthetic signal;
an analyser for analysing the first synthetic signal to create filter coefficients;
a first filter configurable by the created filter coefficients for filtering the first synthetic signal to produce an excitation signal;
circuitry for creating a measure of the excitation signal and for adjusting the excitation signal using the created measure of the excitation signal and the input measure;
a second filter configurable by the input filter coefficients and excitable by the adjusted excitation signal to produce a second synthetic signal; and
a signal combiner for combining the first synthetic signal and the second synthetic signal to create an output signal.
